(19) United States
(12) Patent Application Publication
(10) Pub. No.: US 2007/0246989 A1
(43) Pub. Date: Oct. 25, 2007

(54) ADJUSTABLE HEADREST

(76) Inventor: Mark A. Brockman, Belle River (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/738,190

(22) Filed: Apr. 20, 2007

Related U.S. Application Data
(60) Provisional application No. 60/793,855, filed on Apr. 21, 2006.

(51) Int. Cl. B60N 2/48

(52) U.S. Cl. 297/391; 297/216.12; 297/409

(57) ABSTRACT

An adjustable headrest assembly for a seat includes a frame, a front bracket adjustably moveable toward and away from the frame, and a linking mechanism for guiding the movement of the front bracket. A rack having teeth is mounted to the frame. A locking member is rotatably coupled to the linking mechanism and selectively engages the teeth. The locking member is rotatable between a positioning mode and a return mode. In the positioning mode, the front bracket is adjustable away from the frame to discrete extended positions. In the return mode, the front bracket is adjustable to a retracted position. A biasing device is mounted to the locking member. The biasing device biases the locking member into engagement with the teeth when the biasing device is in the positioning mode and biases the locking member toward disengagement with the teeth when the biasing device is in the return mode.

### CROSS-REFERENCE TO RELATED APPLICATIONS

The subject patent application claims priority to and all the benefits of U.S. Provisional Patent Application Ser. No. 60/793,855 which was filed on Apr. 21, 2006, the entire specification of which is expressly incorporated herein by reference.

### BACKGROUND OF THE INVENTION

1. Field of the Invention

The present invention relates to an adjustable headrest assembly for a seat. More particularly, the present invention relates to an adjustable headrest assembly that is adjustable in a generally horizontal direction toward and away from a head of an occupant.

2. Description of the Related Art

A headrest assembly situated on an upper portion of a seat provides support for an occupant's head and may provide a comfortable resting position for the occupant's head. A variety of designs exist for headrest assemblies. One such variety of designs is an adjustable headrest assembly. Adjustable headrest assemblies may be adjusted in a horizontal direction or in a vertical direction. In particular, horizontally adjustable headrests are adjustable perpendicularly to the upper portion of the seat, i.e., for adjustment toward and away from the head of the occupant. Vertically adjustable headrests are adjustable in a parallel direction with the upper seat, i.e., for adjustment to accommodate different heights of the head of the occupant.

The horizontally adjustable headrest assembly includes a frame and a front bracket spaced from the frame. The frame supports a rear shell and the front bracket supports a front shell. A linking mechanism extends between and is moveably mounted to the frame and to the front bracket. The front bracket is moveable toward and away from the frame. The linking mechanism guides the movement of the front bracket toward and away from the frame. The adjustable headrest assembly includes a rack mounted to the frame and a locking member engageable with the rack. Specifically, the rack presents a row of teeth. The locking member is rotatably coupled to the linking mechanism and rotates about an axis to selectively engage the row of teeth. The front bracket is fixed in position relative to the frame when the locking member is engaged with the row of teeth. Conversely, the front bracket is moveable relative to the frame when the locking member is disengaged with the row of teeth.

One such adjustable headrest assembly is disclosed in United States Patent No. 1,917,587 to Jacobsen (the '587 patent). The '587 patent includes a latch device coupled to the locking member and a push rod mounted to the latch device. The push rod extends through the front shell and terminates at a knob. The push rod is moveable to move the latch to engage and disengage the locking member from the row of teeth. Specifically, the occupant pushes the knob to move the push rod and disengage the locking member from the row of teeth. With the locking member disengaged from the row of teeth, the front bracket is moveable toward and away from the frame. When the occupant locates the desired position of the front bracket relative to the frame, the occupant pulls the knob to move the push rod, thereby engaging the locking member with the row of teeth. Such a design including a knob and a push rod is disadvantageous in that the occupant must search for and locate the knob to adjust the position of the front bracket relative to the frame.

It would be desirable to manufacture a horizontally adjustable headrest assembly that is adjustable without the need for locating a knob or lever to adjust the position of the front bracket relative to the frame.

### SUMMARY OF THE INVENTION AND ADVANTAGES

An adjustable headrest assembly for a seat includes a frame and a front bracket spaced from the frame. The front bracket is adjustably moveable toward and away from the frame. A linking mechanism extends between and is moveably mounted to the frame and to the front bracket. The linking mechanism guides the movement of the front bracket toward and away from the frame. A rack is mounted to the frame and presents a row of teeth. A locking member is disposed on the linking mechanism and is rotatably coupled to the linking mechanism. The locking member is rotatable about an axis and is selectively engageable with the row of teeth. A biasing device is mounted to the locking member and is moveable with the locking member. The biasing device continuously biases the locking member into engagement with the row of teeth when the biasing device and the locking member are in a positioning mode. The biasing device continuously biases the locking member toward disengagement with the row of teeth when the biasing device and the locking member are in a return mode.

Accordingly, the front bracket is moveable relative to the frame between a retracted position, a fully extended position, and discrete intermediate positions therebetween. Specifically, the front bracket is moveable away from the frame, i.e., outwardly, from the retracted position toward the fully extended position and may be maintained in any of the intermediate positions therebetween. To move the front bracket to the retracted position, i.e., inwardly, from any of the intermediate positions or the fully extended position, the occupant moves the front bracket away from the frame and beyond the fully extended position, whereby the locking mechanism moves to the return mode so that the front bracket is moveable inwardly toward the frame. In such a scenario, the occupant moves the front bracket toward the retracted position. Once in the retracted position, the locking mechanism moves to the positioning mode and the front bracket is again moveable from the retracted position toward the fully extended position and any of the intermediate positions therebetween.

As such, the adjustable headrest assembly may be adjusted by merely pulling on the front bracket until the front bracket is in the desired position. In other words, the adjustable headrest assembly does not require a separate lever or knob to be located prior to adjusting the position of the front bracket relative to the frame.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an adjustable headrest assembly;

FIG. 2 is an exploded view of the adjustable headrest assembly;

FIG. 3 is a cross-sectional view of the adjustable headrest assembly with a front bracket in a retracted position;

FIG. 4 is a cross-sectional view of the adjustable headrest assembly with the front bracket in a fully extended position;

FIG. 5 is a cross-sectional view of the adjustable headrest assembly with the front bracket extended beyond the fully extended position;

FIG. 6 is a cross-sectional view of the adjustable headrest assembly with the front bracket approaching the retracted position;

FIG. 7A is a side view of a biasing device;

FIG. 7B is a front view of the biasing device;

FIG. 7C is a perspective view of the biasing device;

FIG. 8A is a perspective view of a locking member;

FIG. 8B is a left-side view of the locking member of FIG. 8A;

FIG. 9 is a perspective view of a rack; and

FIG. 10 is a perspective view of a seat disposed in a vehicle.

### DETAILED DESCRIPTION OF THE INVENTION

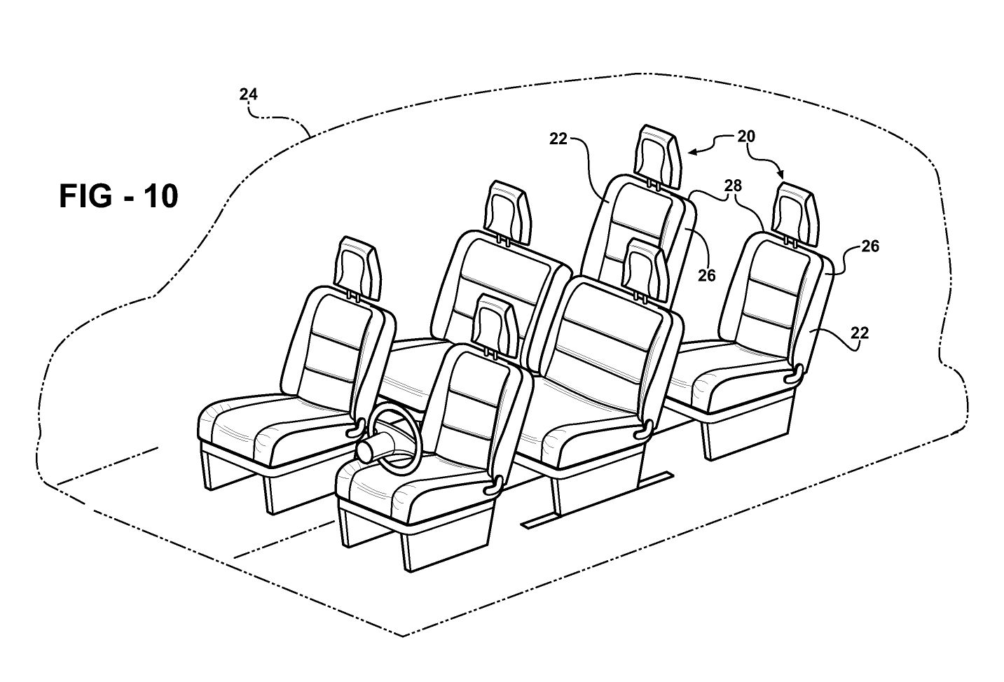

Referring to the Figures, wherein like numerals indicate like parts throughout the several views, an adjustable headrest assembly 20 for a seat 22 is generally shown. For example, as shown in FIG. 10, the adjustable headrest assembly 20 is used in conjunction with the seat 22 disposed in a vehicle 24. The vehicle 24 may be any type of vehicle 24 such as a car, a truck, a van, or a sport utility vehicle 24. Alternatively, the vehicle 24 may be a plane, a train, or a boat. As discussed below, the adjustable headrest assembly 20 is slideably disposed in an upper portion 26 of a back 28 of the seat 22.

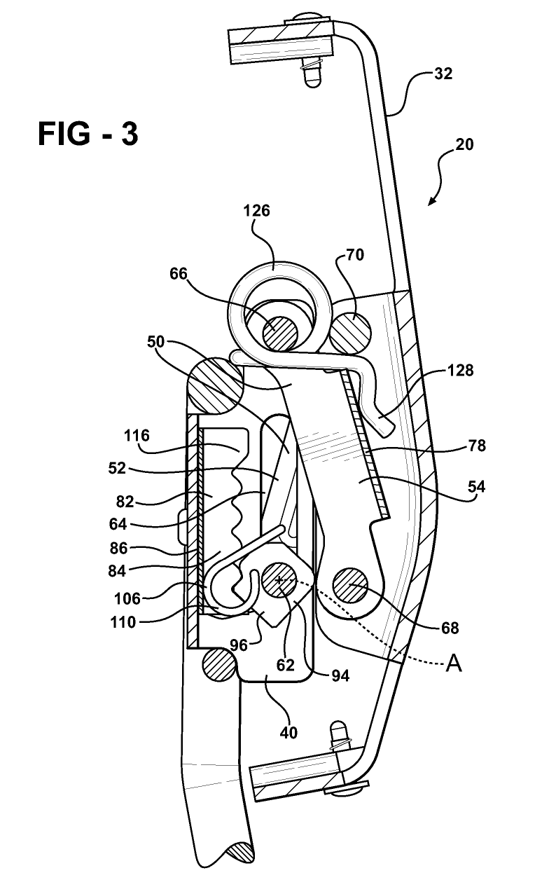

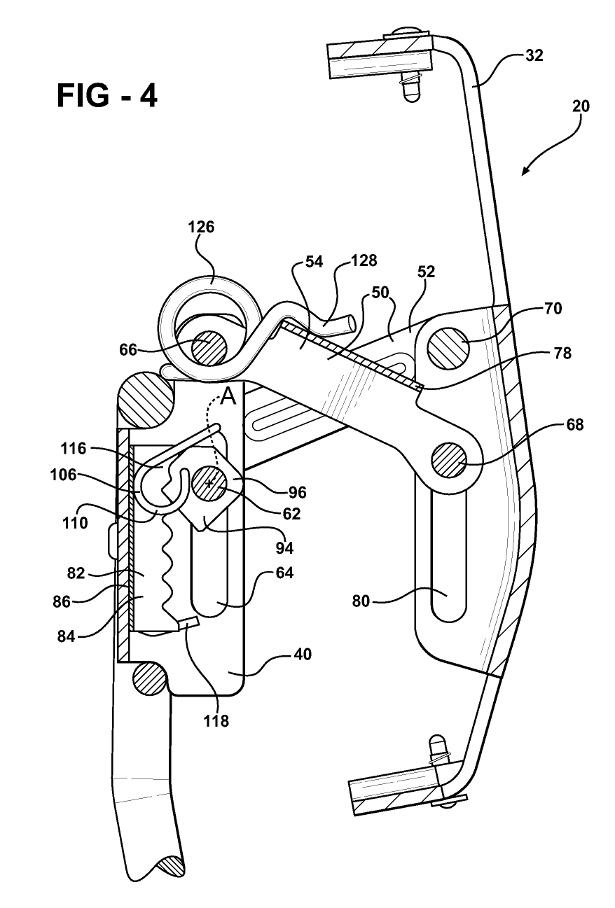

The adjustable headrest assembly 20 includes a frame 30 and a front bracket 32 spaced from the frame 30 for adjustable movement toward and away from the frame 30. As shown in FIGS. 3-6, the front bracket 32 is adjustable in a generally horizontal direction. In other words, the front bracket 32 is adjustable toward and away from a head of an occupant of the vehicle 24. FIG. 3 discloses the front bracket 32 in a retracted position and FIG. 4 discloses the front bracket 32 in a fully extended position. The adjustable headrest assembly 20 enables the occupant to adjust the front bracket 32 between the retracted position and the fully extended position and to discrete intermediate positions therebetween.

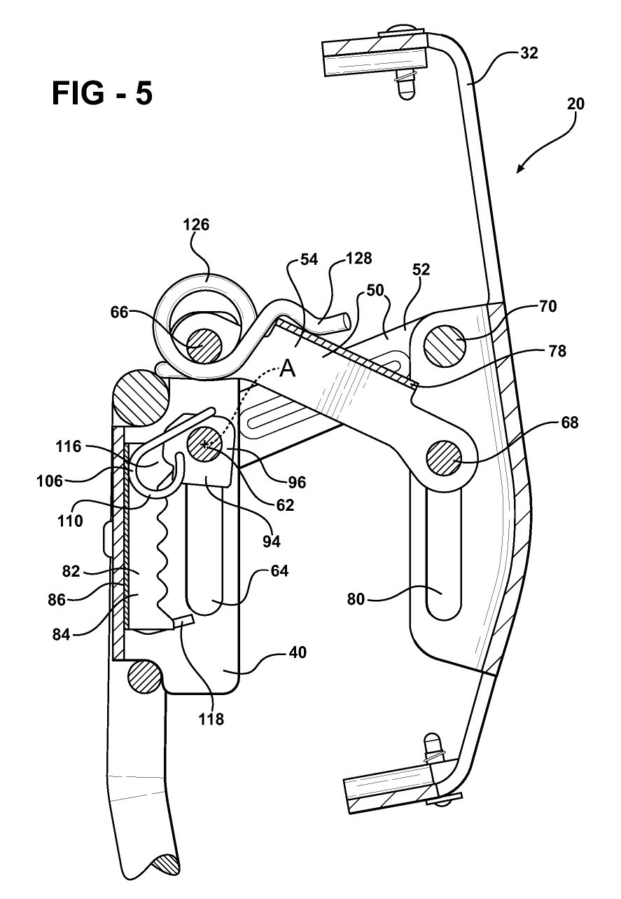

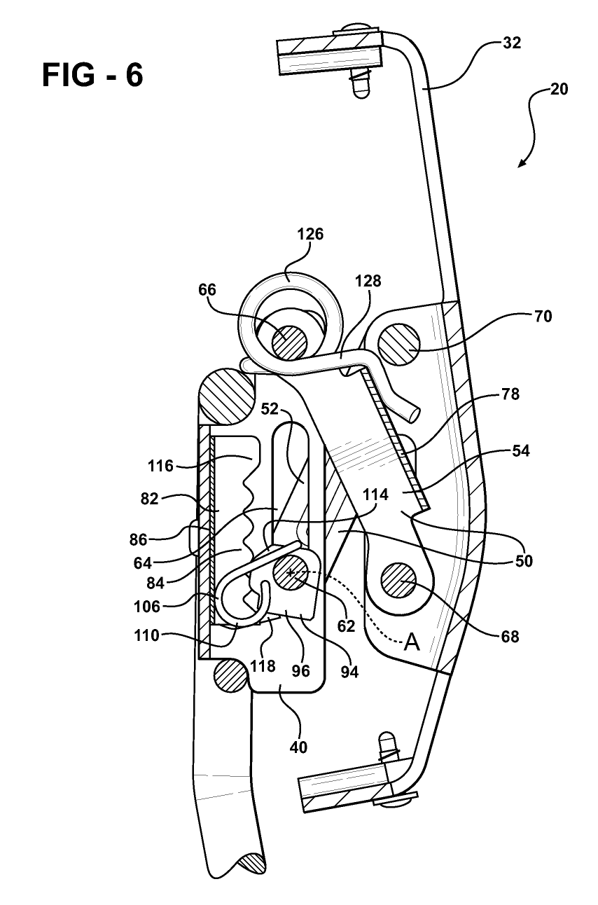

Specifically, the front bracket 32 is moveable away from the frame 30, i.e., outwardly, from the retracted position toward the fully extended position and may be maintained in any of the intermediate positions therebetween. When the front bracket 32 is in any intermediate position or the fully extended position, the front bracket 32 is prevented from moving inwardly toward the frame 30, i.e., the front bracket 32 supports weight such as that of an occupant's head. To move the front bracket 32 to the retracted position, i.e., inwardly, from any of the intermediate positions or the fully extended position, the occupant moves the front bracket 32 away from the frame 30 and beyond the fully extended position, as shown in FIG. 5, whereby the front bracket 32 is moveable inwardly toward the frame 30. In such a scenario, the occupant moves the front bracket 32 toward the retracted position, as shown in FIG. 6. Once in the retracted position, the front bracket 32 is again moveable from the retracted position toward the fully extended position and any of the intermediate positions therebetween.

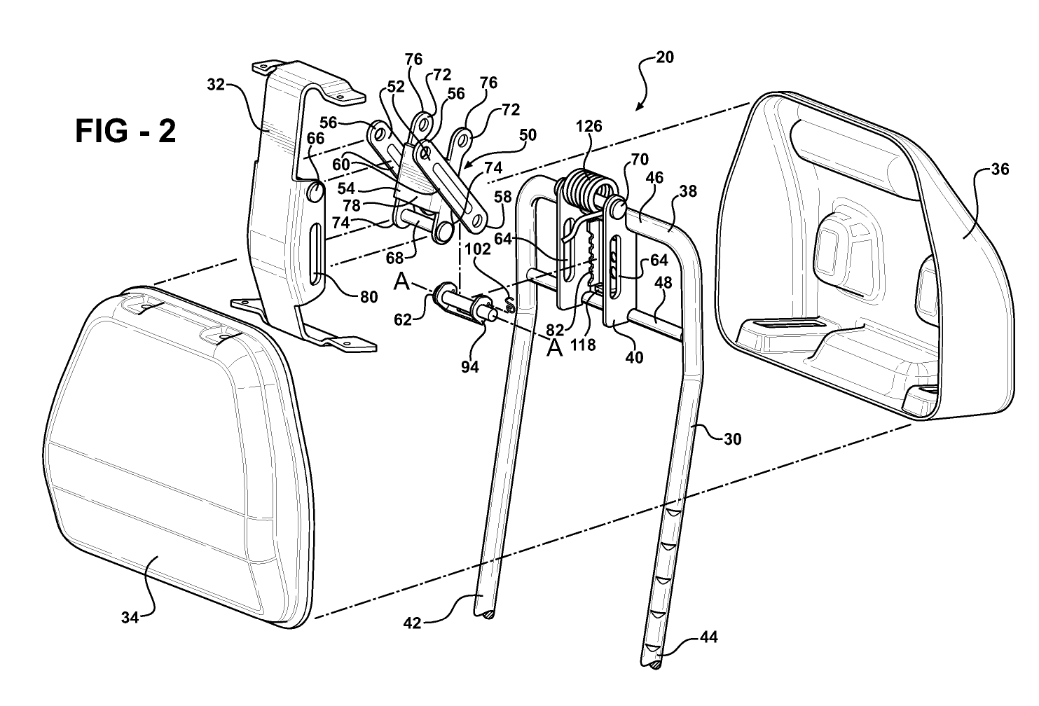

As shown in FIG. 2, the adjustable headrest assembly 20 includes a front shell 34 mounted to the front bracket 32 and a rear shell 36 mounted to the frame 30. The front and rear shells 34, 36 are only shown in FIG. 2 and are not shown in the remaining Figures. The front shell 34 moves with the front bracket 32 and the rear shell 36 remains fixed relative to the frame 30. The shells 34, 36 may be formed from a flexible material, such as a plastic material. A headrest cover (not shown) may be disposed over the adjustable headrest assembly 20 in contact with the front and rear shells 34, 36. Typically, the headrest cover includes an outer skin, e.g., a fabric, matching an outer skin of the seat 22 and further includes an interior fill material, e.g., a foam layer or padding.

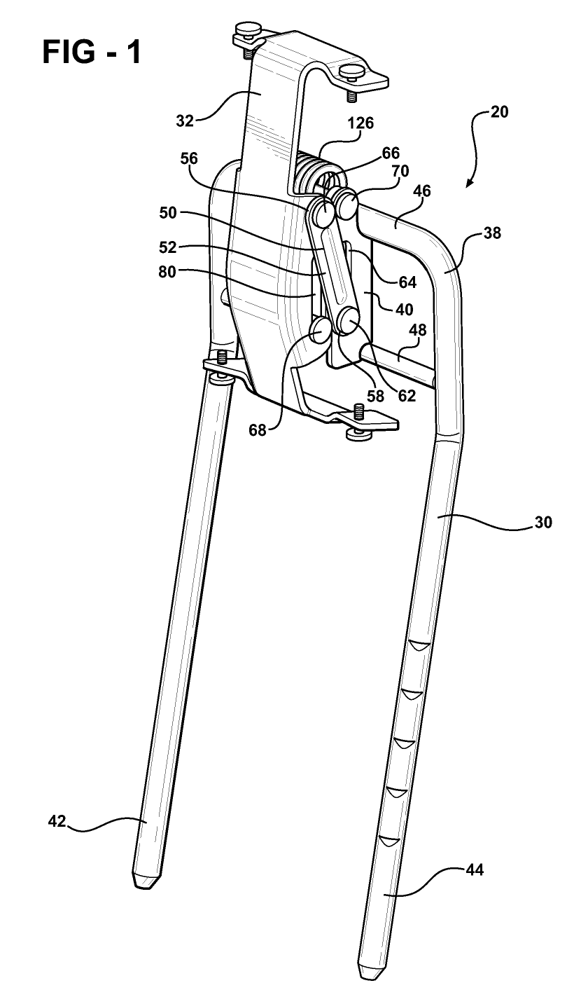

As shown in FIGS. 1-2, the frame 30 includes a frame member 38 and a main bracket 40 mounted to the frame member 38. Specifically, the frame member 38 includes a first and second post 42, 44 for engagement with the upper portion 26 of the seat 22 and a connecting member 46 extending between and fixed to the first and second posts 42, 44, i.e., the frame member 38 is U-shaped. As known to one skilled in the art, the upper portion 26 of the back 28 of the seat 22 receives the first and second posts 42, 44 and the posts 42, 44 are slideably disposed in the upper portion 26 of the back 28 of the seat 22. The first post 42 and/or the second post 44 may define locator notches. The locator notches are utilized to properly locate and secure the posts 42, 44 when slideably disposed in the upper portion 26 of the back 28 of the seat 22.

The frame member 38 includes a rod brace 48 spaced from the connecting member 46 and extending between and fixed to the first and second posts 42, 44. The main bracket 40 extends between and is fixed to the rod brace 48 and the connecting member 46.

As best shown in FIGS. 3-6, a linking mechanism 50 extends between and is moveably mounted to the frame 30 and the front bracket 32 for guiding the movement of the front bracket 32 toward and away from the frame 30. Specifically, the linking mechanism 50 includes a first link 52 and a second link 54 extending in a scissor-like configuration. In other words, one of the links 52, 54 extends diagonally downwardly and the other extends diagonally upwardly from the front bracket 32 to the main bracket 40 thereby forming an X-shape.

More specifically, as shown in FIGS. 1-6, the first link 52 has a first end 56 and a second end 58. The first link 52 extends diagonally downwardly from the front bracket 32 to the main bracket 40. The first end 56 is rotatably engaged with the front bracket 32 and the second end 58 is slideably engaged with the frame 30, and more specifically with the main bracket 40.

As best shown in FIGS. 1-2, the first link 52 is further defined as a pair of rods 60 spaced from each other and extending in parallel. The rods extend from the first end 56 to the second end 58.

As shown in FIGS. 1-6, the first link 52 includes a first pin 62 engaged with the second end 58 of the first link 52. Each of the pair rods defines a hole and the first pin 62 extends between the pair of rods 60 and is rotatably engaged in the holes. The frame 30 defines a first slot 64, and more specifically the main bracket 40 defines the first slot 64. The first pin 62 is slideably engaged with the first slot 64. The first link 52 also includes a third pin 66 rotatably engaged with the first end 56 of the first link 52. The third pin 66 is engaged with the front bracket 32 such that the first link 52 is rotatable relative to the front bracket 32. It should be appreciated that the adjustable headrest assembly 20 includes a plurality of pins and the descriptors “first,” “second,” “third,” etc., are merely descriptors used herein to delineate between each of the pins. Each of the plurality of pins may be similar to each other or may be different from each other.

The second link 54 has a rotatable end 72 rotatably engaged with the frame 30 and a slideable end 74 slideably engaged with the front bracket 32. The second link 54 includes a pair of bars 76 spaced from each other and extending in parallel and a connecting bar 78 extending between and fixed to the pair of bars 76, i.e., the second link 54 is H-shaped. Each of the pair of bars 76 extends between the rotatable end 72 and the slideable end 74. The second link 54 extends between the pair of rods 60 of the first link 52.

The second link 54 includes a second pin 68 coupled to the slideable end 74 of the second link 54. Each of the pair of bars 76 defines a hole and the second pin 68 extends between the pair of bars 76 and is rotatably engaged in the holes. The front bracket 32 defines a front bracket slot 80 with the second pin 68 slideably engaged with the front bracket slot 80. The second link 54 also includes a fourth pin 70 rotatably engaged with the rotatable end 72 of the second link 54. The fourth pin 70 is engaged with the main bracket 40 such that the second link 54 is rotatable relative to the main bracket 40.

As shown in FIGS. 1-6, a rack 82 is mounted to the frame 30, and more specifically, the rack 82 is mounted to the main bracket 40. As shown in FIG. 9, the rack 82 presents a row of teeth 84. Specifically, the rack 82 includes a base 86 and a first and second row of teeth 88, 90 extending in parallel from the base 86 defining a channel 92 therebetween.

A locking member 94 is disposed on and is rotatably coupled to the linking mechanism 50. Specifically, the locking member 94 is rotatably coupled to the second end 58 of the first link 52. The locking member 94 rotates relative to the linking member about an axis A. As will be discussed below, the locking member 94 is selectively engageable with the row of teeth 84.

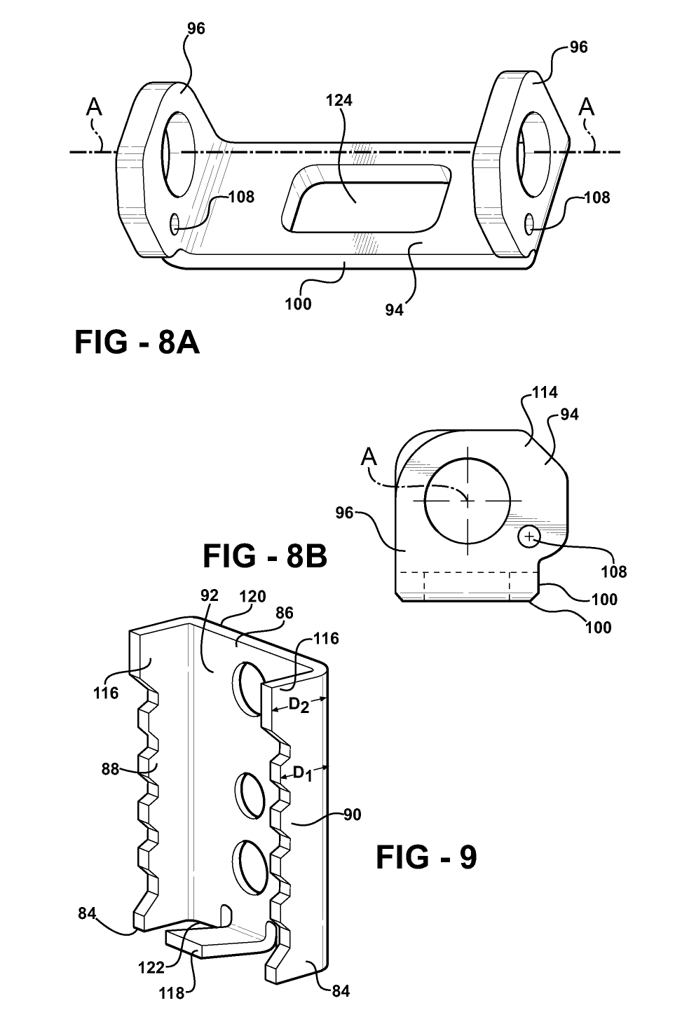

As best shown in FIGS. 8A-B, the locking member 94 includes a pair of end plates 96 and a cross-member 98 extending between and attached to the end plates 96. The cross-member 98 includes an engagement surface 100 selectively engaging the row of teeth 84 in the positioning mode.

As shown in FIGS. 2-7C, the adjustable headrest assembly 20 includes a biasing device 102. The biasing device 102 disclosed in the Figures may be referred to by one skilled in the art as an omega spring, due, in part, to the shape of the biasing device 102.

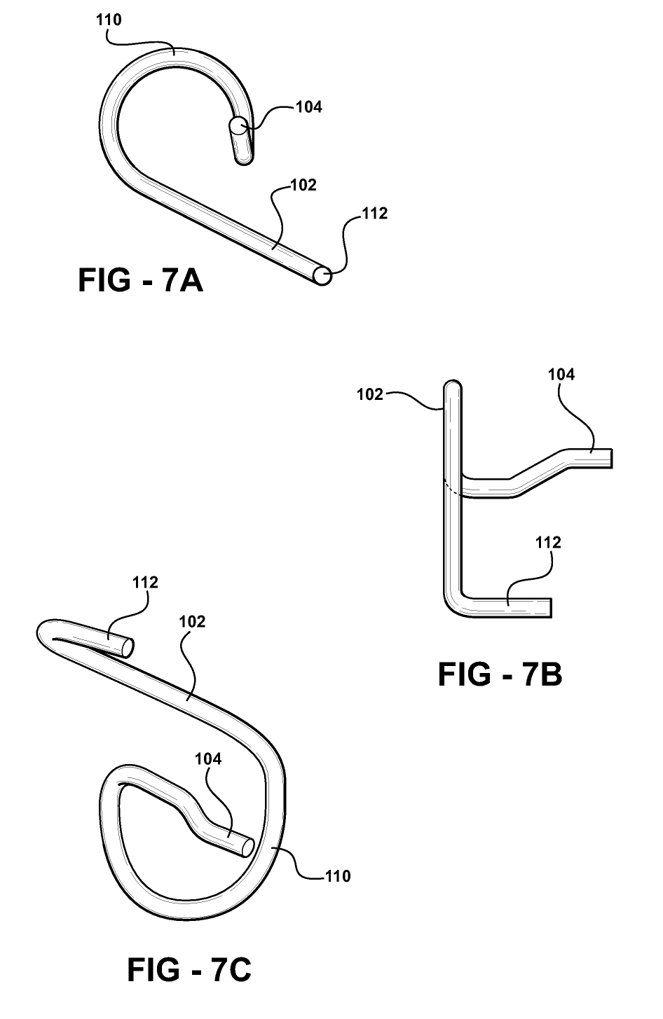

The biasing device 102 is mounted to and moveable with the locking member 94. In other words, the locking member 94 and the biasing device 102 move together as a unit as the locking member 94 moves relative to the rack 82. Specifically, as best shown in FIGS. 7A-C, the biasing device 102 includes a securing portion 104 and a contact portion 106. The securing portion 104 is coupled to the locking member 94. Specifically, the locking member 94 defines an aperture 108 receiving the secured portion of the biasing device 102. As best shown in FIGS. 8A-B, the aperture 108 is spaced from the axis A. It should be appreciated that the locking member defines two apertures 108, as shown in FIGS. 8A-B, and that the biasing device is not received by both apertures 108, but is only received by one of the apertures 108 as shown in FIGS. 3-6.

The contact portion 106 is in slideable contact with one of the rack 82 and the frame 30. FIGS. 3-6 disclose the biasing device 102 extending from the locking member 94 to the base 86 in the channel 92 of the rack 82. In such a configuration, as the locking member 94 moves along the rack 82, the biasing device 102 exerts force on the securing portion 104 thereby moving the biasing device 102 with the locking member 94 while the contact portion 106 slides along the base 86 of the rack 82.

As best shown in FIGS. 7A-C, the biasing device 102 includes a curved portion 110. The curved portion 110 extends between and is continuously compressed between the engaged portion and the contact portion 106 for resiliently biasing the locking member 94 toward the rack 82. In other words, the biasing device 102 is preloaded when mounted in the adjustable headrest assembly 20 between the locking member 94 and the rack 82. The curved portion 110 exerts force on the locking member 94 to bias the locking member 94 toward the rack 82.

The locking member 94 and the biasing device 102 are moveable between a positioning mode and a return mode. The locking member 94 is disclosed in the positioning mode in FIG. 3 and is disclosed in the return mode in FIG. 5. The biasing device 102 continuously biases the locking member 94 into engagement with the row of teeth 84 when the biasing device 102 and the locking member 94 are in the positioning mode. The biasing device 102 continuously biases the locking member 94 toward disengagement with the row of teeth 84 when the biasing device 102 and the locking member 94 are in the return mode.

Specifically, as shown in FIGS. 3-4, in the positioning mode, the engagement surface 100 of the locking member 94 engages the row of teeth 84 on the rack 82. The aperture 108 of the locking member 94 and the securing portion 104 of the biasing device 102 are located vertically above the axis A. In such a position, the biasing device 102 biases the locking member 94 toward the rack 82 in a counter-clockwise direction. As such, the locking member 94 may rotate slightly in a counter-clockwise direction thereby allowing the locking member 94 to move upwardly along the row of teeth 84 when the front bracket 32 is moved away from the frame 30, i.e., allowing outward adjustment. The engagement surface 100 of the locking member 94 in engagement with the row of teeth 84 on the rack 82 prevents the locking member 94 from moving downwardly along the row of teeth 84, thereby preventing the front bracket 32 from moving toward the frame 30, i.e., preventing inward adjustment.

As shown in FIGS. 5-6, in the return mode, the engagement surface 100 of the locking member 94 is disengaged with the row of teeth 84 on the rack 82 thereby allowing the front bracket 32 to move toward the frame 30, i.e., allowing inward adjustment. The aperture 108 of the locking member 94 and the securing portion 104 of the biasing device 102 are located vertically below the axis A. In such a position, the biasing device 102 biases the locking member 94 toward the rack 82 in a clockwise direction.

As best shown in FIG. 5, the biasing device 102 includes a hook 112 extending from the contact portion 106 and engaging the locking member 94 when the locking member 94 rotates to the return mode. The hook 112 and the securing portion 104 exert counteracting forces on the locking member 94 to maintain the locking member 94 in the return mode. Specifically, the end plates 96 of the locking member 94 present a protrusion 114 located such that the protrusion 114 engages the hook 112 when the locking member 94 rotates to the return mode.

As best shown in FIGS. 3-6, the rack 82 includes a ramp 116 and a tab 118 for rotating the locking member 94 between to the return mode and the positioning mode, respectively. Specifically, the rack 82 extends between an upper end 120 and a lower end 122 with the rack 82 including the ramp 116 at the upper end 120 and the tab 118 at the lower end 122.

The ramp 116 is configured to selectively move the securing portion 104 of the biasing device 102 vertically from above the axis A in the positioning mode to below the axis A in the return mode. More specifically, the row of teeth 84 extends linearly and the ramp 116 extends beyond the row of teeth 84. In other words, the row of teeth 84 extends a first distance D1 from the base 86 and the ramp 116 extends a second distance D2 from the base 86 in parallel with the row of teeth 84. The second distance D2 is greater than the first distance D1.

As shown in FIG. 5, as the front bracket 32 is moved away from the frame 30 beyond the fully extended position, the engagement surface 100 of the locking member 94 rides on the ramp 116 thereby rotating the locking member 94 about the axis A from the positioning mode to the return mode. The aperture 108 of the locking member 94 and the securing portion 104 of the biasing device 102 move from a location vertically above the axis A to a location vertically below the axis A. Specifically, FIG. 4 discloses the locking member 94 in the fully extended position with the aperture 108 and the securing portion 104 located vertically above the axis A and FIG. 5 discloses the front bracket 32 moved away from the frame 30 beyond the fully extended position with the aperture 108 and the securing portion 104 located vertically below the axis A. In such a scenario, as discussed above, biasing device 102 rotates the locking member 94 in a clockwise direction and the hook 112 and the securing portion 104 exert counteracting forces on the locking member 94 to maintain the locking member 94 in the return mode. As such, the engagement surface 100 of the locking member 94 remains disengaged with the row of teeth 84 and the front bracket 32 is moveable toward the retracted position.

The tab 118 is configured to selectively move the securing portion 104 of the biasing device 102 from vertically below the axis A in the return mode to vertically above the axis A in the positioning mode. More specifically, the tab 118 extends from the base 86 of the rack 82 between the first and second rows of teeth 88, 90.

As shown in FIG. 6, as the front bracket 32 is moved toward the frame 30, i.e., toward the retracted position, the cross-member 98 of the locking member 94 contacts the tab 118. In such a scenario, when the front bracket 32 is moved further toward the frame 30, the tab 118 forces the cross-member 98 to rotate from the return mode to the positioning mode. The aperture 108 of the locking member 94 and the securing portion 104 of the biasing device 102 move from a location vertically below the axis A to a location vertically above the axis A. As shown in FIG. 3, the locking member 94 is in the positioning mode when the front bracket 32 is in the retracted position. Specifically, FIG. 6 discloses the locking member 94 approaching the tab 118 with the aperture 108 and the securing portion 104 located vertically below the axis A and FIG. 3 discloses the front bracket 32 in the retracted position with the aperture 108 and the securing portion 104 located vertically above the axis A.

The cross-member 98 of the locking member 94 defines a receiving orifice 124 configured to selectively receive the tab 118. In other words, as the locking member 94 in the return mode approaches the tab 118, the receiving orifice 124 receives the tab 118 and forces the locking member 94 to rotate from the return mode to the positioning mode.

A return biasing device 126 is coupled to the frame 30. As best shown in FIGS. 1-2, the return biasing device 126 is a torsion spring. In such a configuration, the return biasing device 126 receives the fourth pin 70 of the second link 54. The return biasing device 126 engages the main bracket 40 and includes an arm 128 engaging the connecting bar 78 of the second link 54. The arm 128 biases rotation of the second link 54 toward the frame 30 to bias the engagement surface 100 of the locking member 94 toward the row of teeth 84. As such, when the occupant moves the front bracket 32 to the retracted position, the fully extended position, or one of the intermediate positions, the return biasing device 126 biases the engagement surface 100 toward engagement with the row of teeth 84 to maintain the front bracket 32 in the respective position. The occupant must overcome the return biasing device 126 when moving the front bracket 32 toward the fully extended position. The return biasing device 126 has a sufficient spring constant to overcome inertia of any moveable parts of the adjustable headrest assembly 20, e.g., the front bracket 32 and the front shell 34, in the case of the vehicle 24 being involved in a front-end crash. The return biasing device 126 overcoming such inertia is advantageous to prevent the adjustable headrest assembly 20 from adjusting as a result of its own inertia during such a vehicle front-end crash.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. An adjustable headrest assembly for a seat, said adjustable headrest assembly comprising:
a frame;
a front bracket spaced from said frame for adjustable movement toward and away from said frame;
a linking mechanism extending between and moveably mounted to said frame and said front bracket for guiding the movement of said front bracket toward and away from said frame;
a rack mounted to said frame and presenting a row of teeth;
a locking member disposed on and rotatably coupled to said linking mechanism about an axis and selectively engageable with said row of teeth; and
a biasing device mounted to and moveable with said locking member for continuously biasing said locking member into engagement with said row of teeth when said biasing device and said locking member are in a positioning mode and for continuously biasing said locking member toward disengagement with said row of teeth when said biasing device and said locking member are in a return mode.

2. The adjustable headrest assembly as set forth in claim 1 wherein said biasing device includes a securing portion coupled to said locking member and a contact portion in slideable contact with one of said rack and said frame.

3. The adjustable headrest assembly as set forth in claim 2 wherein said biasing device includes a curved portion extending between and continuously compressed between said engaged portion and said contact portion for resiliently biasing said locking member toward said rack.

4. The adjustable headrest assembly as set forth in claim 3 wherein said biasing device includes a hook extending from said contact portion and engaging said locking member when said locking member rotates to the return mode and with said hook and said securing portion exerting counteracting forces on said locking member maintaining said locking member in said return mode.

5. The adjustable headrest assembly as set forth in claim 2 wherein said locking member defines an aperture receiving said secured portion of said biasing device with said aperture spaced from said axis.

6. The adjustable headrest assembly as set forth in claim 2 wherein said row of teeth extends linearly and wherein said rack includes a ramp extending beyond said row of teeth configured to selectively move the securing portion of the biasing device from vertically above the axis in the positioning mode to vertically below the axis in the return mode.

7. The adjustable headrest assembly as set forth in claim 6 wherein said rack includes a base with said row of teeth extending a first distance from said base and with said ramp extending a second distance from said base in parallel with said row of teeth with said second distance greater than said first distance.

8. The adjustable headrest assembly as set forth in claim 2 wherein said rack includes a tab configured to selectively move the securing portion of the biasing device vertically from below the axis in the return mode to above the axis in the positioning mode.

9. The adjustable headrest assembly as set forth in claim 8 wherein said locking member includes a cross-member with said cross-member defining a receiving orifice configured to selectively receive said tab.

10. The adjustable headrest assembly as set forth in claim 2 wherein said rack extends between an upper end and a lower end with said rack including a ramp at said upper end for selectively moving the securing portion of the biasing device vertically from above the axis in the positioning mode to below the axis in the return mode and with said rack including a tab at said lower end for selectively moving the securing portion of the biasing device vertically from above the axis in the return mode to below the axis in the positioning mode.

11. The adjustable headrest assembly as set forth in claim 1 wherein said locking member includes a pair of end plates and a cross-member extending between and attached to said end plates.

12. The adjustable headrest assembly as set forth in claim 11 wherein said cross-member includes an engagement surface engaging said row of teeth in said positioning mode.

13. The adjustable headrest assembly as set forth in claim 1 wherein said rack includes a base and a first and second row of teeth extending in parallel from said base defining a channel therebetween.

14. The adjustable headrest assembly as set forth in claim 13 wherein said biasing device extends from said locking member to said base in said channel of said rack.

15. The adjustable headrest assembly as set forth in claim 1 wherein said linking mechanism includes a first link having a first end and a second end with said first end rotatably engaged with said front bracket and with said second end slideably engaged with one of said frame and said rack.

16. The adjustable headrest assembly as set forth in claim 15 wherein said first link includes a first pin engaged with said second end of said first link and wherein frame defines a first slot with said first pin slideably engaged with said first slot.

17. The adjustable headrest assembly as set forth in claim 1 wherein said first link is further defined as a pair of rods spaced from each other and extending in parallel.

18. The adjustable headrest assembly as set forth in claim 1 wherein said linking mechanism includes a second link having a rotatable end rotatably engaged with said frame and a slideable end slideably engaged with said front bracket.

19. The adjustable headrest assembly as set forth in claim 19 wherein said second link includes a second pin coupled to said slideable end of said second link and wherein said front bracket defines a front bracket slot with said second pin slideably engaged with said front bracket slot.

20. The adjustable headrest assembly as set forth in claim 19 wherein said second link includes a pair of bars spaced from each other and extending in parallel and a connecting bar extending between and fixed to said pair of bars.

21. The adjustable headrest assembly as set forth in claim 20 further including a return biasing device coupled to said frame and including an arm engaging said connecting bar and biasing rotation of said second link toward said frame.

22. The adjustable headrest assembly as set forth in claim 1 wherein said frame includes a frame member and a main bracket mounted to said frame member with said rack mounted to said main bracket.

23. The adjustable headrest assembly as set forth in claim 22 wherein said frame member includes a first and second post for engagement with an upper portion of a seat and a connecting member extending between and fixed to said first and second posts.

24. The adjustable headrest assembly as set forth in claim 23 wherein said frame member includes a rod brace spaced from said connecting member and extending between and fixed to said first and second posts and wherein said main bracket extends between and is fixed to said rod brace and said connecting member.

25. The adjustable headrest assembly as set forth in claim 1 further including a front shell mounted to said front bracket and a rear shell mounted to said frame.
